(19) United States
(12) Patent Application Publication
(10) Pub. No.: US 2007/0291905 A1
(43) Pub. Date: Dec. 20, 2007

(54) A Test System and method of Operation

(75) Inventors: David J. Halliday, West Leake (GB); Steve J. Lakin, Donisthorpe (GB)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/424,432

(22) Filed: Jun. 15, 2006

(51) Int. Cl. H04M 1/24; H04M 3/08; H04M 3/22

(52) U.S. Cl. 379/1.01

(57) ABSTRACT

A test system comprises a test processor which is arranged to perform hardware level tests on a unit under test. A voice interface interfaces to an external voice communication link coupled to a remote voice communication unit. A test controller is coupled to the test processor and the voice interface and comprises a script processor for executing a test control script. The test control script is in accordance with a voice scripting language standard, such as the Voice extensible Markup Language, VXML, standard. The script processor comprises a first interface for interfacing with the test processor in response to the test control script and a second interface for interfacing with the voice interface in response to the test control script. The invention may allow a user friendly speech interface to a hardware level test system.

### FIELD OF THE INVENTION

The invention relates to a test system and method of operation and in particular, but not exclusively, to hardware level testing of electronic assemblies.

### BACKGROUND OF THE INVENTION

In order to facilitate and reduce the cost of implementation of complex electronic equipment, there is an increasing drive towards interoperability between different manufacturers. Furthermore, testability of electronic assemblies is becoming increasingly important in order to ensure high reliability and early fault detection.

Specifically, in order to facilitate implementation of hardware for telecommunication applications, the PCI Industrial Computer Manufacturers Group (PICMG™) has developed hardware standards known as Telecom Computing Architecture (TCA) standards. The standards define a number of parameters such as mechanical features (e.g. rack size, board size), electrical features (e.g. supply voltages, max power consumptions) and interworking features (e.g. backplane communication characteristics) which allow standard hardware modules and elements from different vendors to be used together. Specifically, the MicroTCA standard has been developed to provide a flexible and efficient interworking for smaller modules with lower power consumptions.

In order to provide improved testability, a number of test methods and procedures have also been standardised. For example, TCA systems often implement support for boundary scan /JTAG (Joint Test Action Group) testability for preferably both in-deployment (e.g. customer accessible) and for manufacturer test purposes. Such test functionality allows detailed hardware level tests to be performed to verify the operation of the system.

TCA test systems typically provide an interface to an external test station that can be used to control the performed testing and interpret the obtained test results. For example, an RS232 port may be provided for coupling an external laptop computer to the test system. The laptop computer then executes a dedicated and vendor specific test program which interprets the test results and presents the health status of the equipment to a test operator.

However, such an approach tends to be inflexible and provide a limited user experience. Specifically, prior art approaches tend to require dedicated test and/or vendor specific software to be executed in order to evaluate the test results. Furthermore, the test results are either interpreted locally or complex functionality is used to communicate the test results to remote stations for processing.

Hence, an improved system would be advantageous and in particular a system allowing increased flexibility, reduced complexity, reduced cost, facilitated status reporting, facilitated test control, facilitated interfacing and/or vendor specific functionality and/or improved user friendliness would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a test system comprising: a test processor arranged to perform hardware level tests on a unit under test; a voice interface for interfacing with an external voice communication link coupled to a remote voice communication unit; and a test controller coupled to the test processor and the voice interface means and comprising: a script processor for executing a test control script, the test control script being in accordance with a voice scripting language standard; a first interface for interfacing with the test processor in response to the test control script; and a second interface for interfacing with the voice interface in response to the test control script.

The invention may allow an improved test system. In particular, the invention may allow an improved user interface for a hardware level test system. The invention may in particular allow simple remote operation and control of the test system using standard voice communication means, such as e.g. a cellular mobile phones. The invention may allow a facilitated and/or improved user experience.

The unit under test may for example be a TCA assembly and/or may be e.g. one or more blades, modules, boards and/or subsystems of a TCA assembly. The test controller may specifically comprise a Joint Test Access Group (JTAG) Test Access Port (TAP) controller. The test processor may be arranged to perform a boundary scan test, a functional board level test and/or a system level test of the unit under test.

The voice scripting language may specifically be a Voice extensible Markup Language, VXML.

The test control script may control the script processor to control the test operation of the test processor in response to data received from the voice interface. Alternatively or additionally, the test control script may control the script processor to receive test data from the test processor and in response generate voice output data which is transmitted to the voice interface and the external voice communication link. Thus, the first interface may transmit data to and/or receive data from the test processor. Likewise, the second interface may transmit data to and/or receive data from the voice interface.

According to an optional feature of the invention, the test controller comprises a speech synthesis processor for outputting synthesized speech to the external voice communication link.

The synthesized speech may for example correspond to test result data from the test processor.

The invention may allow a hardware level test system to provide a speech output for reporting e.g. fault status, health status, test results etc. The reporting may use standard communication approaches thereby allowing a practical and/or easy to implement reporting to remote locations.

According to an optional feature of the invention, the voice interface comprises a speech recognition processor for determining input control data in response to voice data received from the external voice communication link and wherein the script is arranged to generate test control data for the test processor in response to the input control data.

The invention may allow a hardware level test system to provide speech control of test operations and may in particular allow a practical, user friendly and/or easy to implement remote control of a hardware level test system.

According to another aspect of the invention, there is provided a method of operation for a test system comprising: a test processor performing hardware level tests on a unit under test; a voice interface interfacing with an external voice communication link coupled to a remote voice communication unit; and a test controller, coupled to the test processor and the voice interface, performing the steps of: executing a test control script, the test control script being in accordance with a voice scripting language standard; interfacing with the test processor in response to the test control script; and interfacing with the voice interface in response to the test control script.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a test system in accordance with some embodiments of the invention;

FIG. 2 illustrates an example of a test controller for a test system in accordance with some embodiments of the invention;

FIG. 3 illustrates a communication system comprising a test system in accordance with some embodiments of the invention; and

FIG. 4 illustrates an example of a method of operation for a test system in accordance with some embodiments of the invention.

### DETAILED DESCRIPTION OF SOME EMBODIMENTS OF THE INVENTION

The following description focuses on embodiments of the invention applicable to a test system embedded in a TCA hardware assembly. However, it will be appreciated that the invention is not limited to this application but may be applied to many other systems.

FIG. 1 illustrates a test system 101 in accordance with some embodiments of the invention. The test system 101 is in the specific example part of a TCA hardware assembly and is arranged to perform tests of subsystems of the TCA assembly such as of individual or groups of mezzanine cards, modules or blades.

In FIG. 1, a unit under test 103 is coupled to the test system 101 for testing. Although FIG. 1 illustrates only a single unit under test 103, it will be appreciated that the test system may be arranged to test a plurality of different modules, cards subsystems etc. Specifically, in different embodiments, the unit under test 103 may be considered to correspond to a single hardware element (e.g. a card, board, module or blade), a plurality of hardware elements or all hardware elements of the TCA assembly.

The unit under test 103 is coupled to a test processor 105 of the test system 101 through a Joint Test Action Group (JTAG) interface connection.

The test processor 105 comprises functionality for performing various test operations on the unit under test 103. Specifically, the test processor 105 can perform JTAG test operations on the unit under test 103 in accordance with the IEEE standard no. 1149.1 “Standard Test Access Port and Boundary-Scan Architecture” defined by the Joint Test Action Group. This test approach allows detailed hardware level testing including boundary scan testing, programmable device upgrades and fault insertion testing. Boundary scan testing is typically performed at the time of board assembly but can also be performed in-deployment.

Thus, in the example of FIG. 1, the unit under test 103 is coupled to the test processor 105 through one or more JTAG connections. Each JTAG connection comprises four or five interface lines for clock and data signals as will be known to the person skilled in the art. Furthermore, the test processor 105 comprises a Test Access Port (TAP) controller which can perform the boundary (etc) tests on the unit under test. It will be appreciated that the test processor 105 may be arranged to include a separate TAP controller functionality for each JTAG connection allowing e.g. parallel or sequential test of a plurality of different subsystems or modules.

The test processor 105 can thus perform test operations such as boundary scan tests, functional board level tests and/or system level tests of the unit under test 103, which may specifically be the whole TCA assembly.

The test processor 105 is coupled to a test controller 107 which is further coupled to an external voice interface 109. The external voice interface 109 provides an interfacing of the test system 101 to an external communication link. The external communication link carries voice data to and/or from a remote voice communication unit. In some embodiments the voice data carried on the external communication link may simply be PCM (Pulse Code Modulated) voice data as is frequently used in traditional Public Switched Telephone Networks (PSTNs). In other embodiments, the voice data may alternatively or additionally be encoded in accordance with a suitable speech encoding algorithm, such as the Adaptive Multi Rate (AMR) speech coding algorithm standardised for some cellular communication systems.

Thus, the external voice interface 109 interfaces the test system to an external voice communication system. In a simple embodiment, the external voice interface 109 may simply be coupled to a conventional PSTN line. In other embodiments, the external voice interface 109 can e.g. be coupled to a complex cellular communication network and/or Internet based communication network. The external voice interface 109 allows the test system 101 to receive speech commands and requests from a user of the remote voice communication unit. In addition, the external voice interface 109 allows for spoken test results and status reports to be generated by the test system and communicated to the remote voice communication unit. Thus, the test system 101 provides a practical and user-friendly interface to a test operator using the remote voice communication unit. The test operator may interact with the test system 101 using spoken commands and requests, and can receive spoken information from the test system. The test operator can furthermore be remotely located and can access the test system 101 from any location that provides a voice communication link to the test system. For example, the remote voice communication unit may be a conventional cellular mobile phone allowing the test operator access to the test system 101 from a wide range of remote locations.

The test controller 107 is arranged to control the operation of the test processor 105 in response to the requests and commands received from the test operator. In addition, the test controller 107 can receive test results from the test processor 105 and can control the reporting of such test results to the test operator using a voice communication link. The test controller 107 specifically executes a test control script which is written in a voice scripting language. Thus, the test controller 107 effectively implements a voice browser using a standardised voice scripting language thereby providing the speech interface for the test operator.

The use of the script language allows a flexible and highly efficient system to be developed. Specifically, the test control script allows ease implementation of complex test control processes that can be managed by a test operator using spoken inputs. Likewise, the test control script allows a large degree of flexibility for processing test result data prior to this being presented to the user in a suitable and easy to understand speech format.

In the test system 101 of FIG. 1, the test control script is a Voice extensible Markup Language (VXML) script. Specifically, the control script can be a VXML 2.0 script although other versions may be used in other embodiments.

VXML is a markup language for building speech interfaces and can be considered to be the voice equivalent of the HyperText Markup Language (HTML) which is used for many Internet applications. The test controller 107 of FIG. 1 implements a voice browser. A voice browser is similar to a Web browser and interprets VoiceXML scripts to present spoken information to users and also accepts spoken requests from them. Spoken requests is a particular feature of version 2.0 allowing a completely voice modal system. The test controller 107 thus implements a voice browser which uses a VXML test control script to provide a speech interface that allows a test operator to e.g. retrieve hardware level status reports, run diagnostics, receive fault indications etc. using e.g. a standard (mobile) phone.

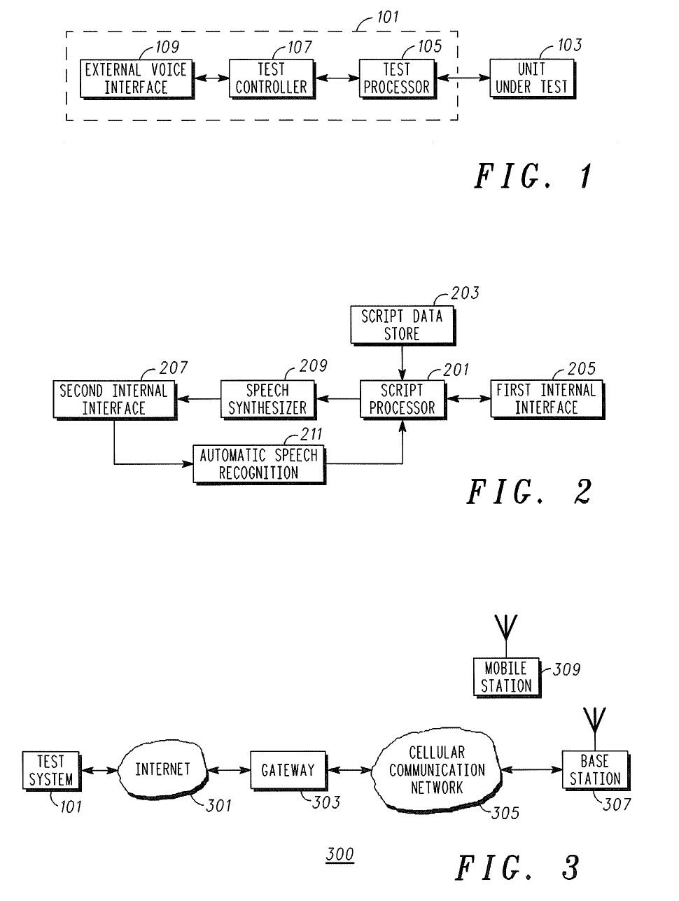

FIG. 2 illustrates the test controller 107 in more detail.

The test controller 107 comprises a script processor 201 which is coupled to a script data store 203. The test control script is stored in the script data store 203 and can be retrieved by the script processor 201. The script processor 201 is arranged to execute the test control script thereby implementing a speech user interface to the test system 101 for the remote voice communication unit.

The script processor 201 comprises a VXML interpreter which processes the individual commands and data structures of the test control script. The script processor 201 is furthermore coupled to a first internal interface 205 which provides an interface to the test processor 105.

The script processor 201 may in response to an interpretation of specific commands in the test control script transmit test control instructions, commands, test input data etc to the test processor 105 via the first internal interface 205.

Likewise, the script processor 201 may receive test results data from the test processor 105 from the first internal interface 205. The test control script may comprise instructions for processing and manipulating such test result data.

The test controller 107 furthermore comprises a second internal interface 207 which interfaces to the external interface 111. In the example, the interface between the test controller 107 and the external interface 111 is a voice data interface.

It will be appreciated that although the first and second internal interface 205, 207 are shown as individual and separate functional blocks, they may be implemented e.g. as a simple data transfer or interaction between e.g. different firmware or software routines running on the same processor as the script.

The test controller 107 comprises a speech synthesiser 209 which is coupled to the script processor 201 and the second internal interface 207. The speech synthesiser 209 is arranged to generate synthetic speech data in response to data received from the script processor 201. Thus, the test control script executed by the script processor 201 can comprise instructions that specify that data should be fed to the speech synthesiser 209. In response, the speech synthesiser 209 generates synthesised voice data which is fed to the external interface 111 via the second internal interface 207. The speech data is then forwarded by the external interface 111 to the remote voice communication unit. Thus, the test control script can command synthetic speech to be generated and transmitted to the remote voice communication unit.

In the example, the test controller 107 also comprises an automatic speech recogniser 211 which is coupled to the script processor 201 and the second internal interface 207. The automatic speech recogniser 211 is arranged to receive voice data from the external interface 111 via the second internal interface 207 and to perform a speech recognition to detect the command, request or data spoken by the test operator. The recognised data can then be processed by the script processor 201 to effect the desired operation of the test system 101.

In some embodiments, the test control script can define a limited set of input commands and data that may be provided by the test operator. The set of input commands and data can be fed to the automatic speech recogniser 211 which can perform the speech recognition in response thereto. This may allow a higher reliability of the speech recognition.

Thus, the hardware level test system if FIG. 1 comprises functionality for executing a VXML script in order to provide a remote speech interface that can allow a test operator to interact with the test system using simple speech interaction and using a conventional speech communication device such as a mobile phone. This may allow a highly efficient and user-friendly hardware test interface.

For example, the test operator may use a cellular mobile phone to access the test system. A simple spoken command can be conveyed to the test system through a voice communication link. The voice data is fed to the automatic speech recogniser 211 which performs speech recognition to identify which command has been issued. The script processor 201 executes the test control script to process the command data and the script determines the action which is associated with the command. The script then proceeds to generate test control data which is fed to the test processor 105 and which causes this to perform the required action.

For example, the test operator may simply issue a statement like “Start Test A”. This will be interpreted by the automatic speech recogniser 211. The VXML script will in response to receiving this data then identify Test A, which for example may correspond to a boundary scan of a specific module of the TCA assembly. The test control script then he generates the required test control data which will result in the required boundary scan being performed by the test processor 105. The generated test control data is then fed to the test processor 105 which accordingly proceeds to perform the test.

When the test has finished, the test processor 105 feeds the test results to the test controller 107. The test result data is fed to the script processor 201 and the test control script proceeds to interpret the data. Specifically, the VXML script determines one or more report statements that should be issued to the test operator. Data indicative of these statements is then fed to the speech synthesiser 209 which proceeds to generate the synthesised speech data. The speech data is then fed to the external interface which communicates the speech data to the remote voice communication unit.

It will be appreciated that in some embodiments the test control script may simply cause the received test data to be fed directly to the speech synthesiser 209. However, alternatively or additionally, the script processor 201 may include some processing of the test result data. As a simple example, the test control script may select between a set of predetermined test report statements depending on the test results. The selected test report statement is then fed to the speech synthesiser 209. In a simple embodiment, the test report statements can simply consist in one statement indicating that a fault was detected and another statement indicating that no-fault was detected.

For example, in response to the test operator issuing the simple statement of “Start Test A”, the test system may perform the desired test and provide a spoken response such as “Fault Detected” or “Test OK” depending on the outcome of the test.

In some embodiments, the test control script can furthermore be arranged to provide additional information to the test operator. For example, the test control script can be arranged to provide information to the user of which commands and input data are available at any given time. For example, the test control script can be arranged to provide data to the speech synthesizer 209 that will result in the speech synthesizer 209 listing the options which are available to the user.

Specifically, the test control script can first determine which test options are available. This can e.g. be determined through data which is specifically embedded in the test control script itself and/or can for example be determined by the script processor 201 through interaction with the test processor 105. As an example, the test control script can cause the speech synthesizer 209 to generate a sentence such as “To perform a boundary test scan of module A say “Start Test A”. To perform a boundary test scan of module B say “Start Test B”. To perform a boundary test scan of module C say “Start Test C”. After hearing this list of options, the test operator may for example say the command “Start Test A” resulting in the boundary test scan of module A as previously described.

Furthermore, in some embodiments, the test system 101 may in addition be arranged to communicate with the remote voice communication unit through other means than by speech. For example, in the case of a mobile phone, the test system may also be arranged to transmit text or images to the mobile phone for presentation on the display of the mobile phone.

Similarly, the test system 101 can comprise functionality for receiving other control input than spoken commands from the remote voice communication unit. Specifically, the test operator may provide input data to the test system 101 using the keyboard of a mobile phone.

In some embodiments, the test system 101 can comprise functionality for receiving and decoding a Dual Tone Multi-Frequency, DTMF, signal. This may allow a detection of key presses for e.g. telephones using a DTMF system. The test control script can then control the test processor 105 in response to this information. For example, the test operator may initiate a test of a module of the TCA assembly by pressing a key on the keypad of the mobile phone. Thus, a combination of keypad combinations and spoken word input to the test system can be used to provide e.g. diagnostic stimulus and health/results queries.

It will be appreciated, that the communication link between the test system 101 and the remote voice communication unit used by the test operator may be any communication link for carrying voice communication. For example, the communication link can simply be a traditional PSTN connection to a traditional PSTN telephone.

As another example, the communication link may be fully or partially formed by a communication link of the cellular communication system, such as a GSM or a UMTS cellular communication system. As another example, the communication link may be fully or partially formed by a Voice over Internet Protocol (VoIP) communication system and particularly may be formed at least partially be a VoIP link over the Internet.

FIG. 3 illustrates a specific example wherein the communication link is formed through a communication system 300 comprising both the Internet and a cellular communication system.

In the communication system 300, the test system 101 is coupled to the Internet 301. Thus, the external voice interface 109 comprises an interface to the Internet 301.

The Internet 301 is coupled to a Gateway 303 that provides an interworking function between the Internet 301 and a cellular communication network 305 which may for example be a GSM or UMTS cellular communication system. Specifically, the cellular communication network may comprise an IP Multimedia Subsystem (IMS) network supporting VoIP.

The cellular communication network 305 is coupled to a base station 307 which is arranged to communicate with remote stations over the air interface of the cellular communication system. Specifically, the base station 307 can communicate with a mobile station 309 over the air interface. In the example, the mobile station 309 corresponds to the remote voice communication unit used by the test operator.

In the example, the external voice interface 109 and the mobile station 309 comprise functionality for setting up and maintaining the voice communication using the Session Initiation Protocol (SIP). Furthermore, when the session has been initiated, the external voice interface 109 and the mobile station 309 communicate the voice data using the Real Time Protocol (RTP).

The described system allows a user friendly interface to a hardware level test system. Furthermore, a practical and easy to implement approach for remote control of the test system can be achieved. The approach may reuse existing communication infrastructure to provide an enhanced and new way of interacting with a hardware level test system. For example, by building on the IETF SIP and RTP standards, it is relatively straightforward to implement a system that allows the test system to provide the enhanced functionality.

Furthermore, the required functionality can be added to traditional hardware level test systems without substantially increasing the cost or complexity of these. Specifically, in many embodiments the required functionality can at least partly be performed by the processing unit responsible for performing the hardware tests. For example, in a MicroTCA assembly, the functionality can in many cases be implemented by the JTAG Switching Module responsible for performing the tests of the assembly.

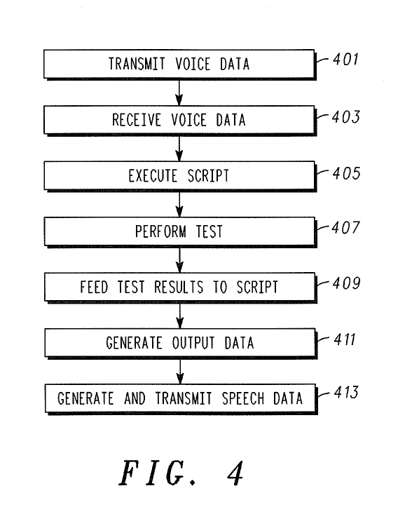

FIG. 4 illustrates an example of a method of operation for a test system in accordance with some embodiments of the invention.

The method initiates in step 401 wherein the remote voice communication unit 309 transmits voice data to the test system 101.

Step 401 is followed by step 403 wherein the voice data is received by the test controller 107 from the voice interface 109 of the test system 101.

Step 403 is followed by step 405 wherein the script processor 201 executes the test control script and generates test control data for the test processor 105 in response to the received voice data. The test control data is then fed to the test processor 105 from the test controller 107.

Step 405 is followed by step 407 wherein the test processor 105 performs a hardware level test of a unit under test.

Step 407 is followed by step 409 wherein the test result data is fed to the test controller.

Step 409 is followed by step 411 wherein the script processor 201 processes the test result data and generates output data for the voice communication unit 309.

Step 411 is followed by step 413 wherein the output data is converted to speech data and the speech data is transmitted to the remote voice communication node 309.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A test system comprising:
a test processor arranged to perform hardware level tests on a unit under test;
a voice interface for interfacing with an external voice communication link coupled to a remote voice communication unit; and
a test controller coupled to the test processor and the voice interface means and comprising:
a script processor for executing a test control script, the test control script being in accordance with a voice scripting language standard,
a first interface for interfacing with the test processor in response to the test control script, and
a second interface for interfacing with the voice interface in response to the test control script.

2. The test system of claim 1 wherein the test controller comprises a speech synthesis processor for outputting synthesized speech to the external voice communication link.

3. The test system of claim 2 wherein the test controller is arranged to receive test output data from the test processor and the test control script is arranged to cause the test controller to generate the synthesized speech in response to the test output data.

4. The test system of claim 2 wherein the test controller comprises means for determining test option data indicative of test options of the test processor and the script is arranged to cause the test controller to generate the synthesized speech in response to the test option data.

5. The test system of claim 1 wherein the voice interface comprises a speech recognition processor for determining input control data in response to voice data received from the external voice communication link and wherein the script is arranged to generate test control data for the test processor in response to the input control data.

6. The test system of claim 5 wherein the test processor is arranged to control a test operation in response to the test control data received from the test controller.

7. The test system of claim 6 wherein the script is arranged to determine if the input control data corresponds to a request for an initiation of a specific test and in response to generate test control data causing the test processor to activate the specific test.

8. The test system of claim 1 wherein the voice interface comprises a Dual Tone Multi-Frequency, DTMF, processor for determining input control data in response to DTMF data received from the external voice communication link and wherein the script is arranged to generate test control data for the test processor in response to the input control data.

9. The test system of claim 1 wherein the test processor is arranged to perform a boundary scan of the unit under test.

10. The test system of claim 1 wherein the voice scripting language standard is a Voice extensible Markup Language, VXML, standard.

11. The test system of claim 1 wherein the external voice communication link comprises a communication link of at least one of the communication systems selected from the group consisting of:
a) a cellular communication system;
b) an Internet Protocol network; and
c) a Public Switched Telephone Network, PSTN.

12. The test system of claim 1 wherein the remote voice communication unit is a cellular mobile telephone.

13. The test system of claim 1 wherein the voice interface is arranged to communicated with the remote voice communication unit using a Session Initiation Protocol, SIP.

14. The test system of claim 1 wherein the voice interface is arranged to communicated with the remote voice communication unit using a Real Time Protocol, RTP.

15. A method of operation for a test system comprising:
a test processor performing hardware level tests on a unit under test;
a voice interface interfacing with an external voice communication link coupled to a remote voice communication unit; and
a test controller, coupled to the test processor and the voice interface, performing the steps of:
executing a test control script, the test control script being in accordance with a voice scripting language standard;
interfacing with the test processor in response to the test control script; and
interfacing with the voice interface in response to the test control script.
